(19) United States
(12) Patent Application Publication
(10) Pub. No.: US 2011/0011951 A1
(43) Pub. Date: Jan. 20, 2011

(54) Compressed air assisted high pressure nozzle wherein material, (e.g. liquid, slurry, sand, dry matter, ect.) is drawn into the inlet and expelled through the outlet as the result of the introduction of compressed air into the nozzle.

(76) Inventor: Jerome Lofthouse, Carson City, NV (US)

Correspondence Address: Jerome Lofthouse, 1600 Airport Rd., Apt. 45, Carson City, NV, 89701, US

(21) Appl. No.: 12/803,606

(22) Filed: Jun. 30, 2010

Related U.S. Application Data
(60) Provisional application No. 61/271,405, filed on Jul. 20, 2009.

(51) Int. Cl. B05B 7/04

(52) U.S. Cl. 239/398

(57) ABSTRACT

The invention relates to a nozzle that has direct compressed air injection into the nozzle. The injection of compressed air directly into the nozzle thereby eliminates the need for additional means by any separate apparatus to collect the material prior to discharge of the material. The compressed air in the nozzle results in the material being drawn into the nozzle's hollow rod upstream inlet end and simultaneously discharged through the chamber's downstream outlet end through the attached female end of the external hollow rod. The invention can be used for liquid, slurry or dry material and can be immediately switched from one type of material to another without making any adaptations or changes to the invention.

### CROSS-REFERENCE TO RELATED APPLICATIONS

The inventors, Jerome Lofthouse and Carlos Yanez, hereby claim the benefit of a certain provisional patent application filed on Jul. 20, 2009 as application Ser. No. 61/271,405.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

Compressed air assisted high pressure nozzle wherein material, (e.g., liquid, slurry, sand, dry material, etc.) is drawn into the inlet and expelled through the outlet as a result of the introduction of compressed air into the nozzle.

### BACKGROUND OF INVENTION

This invention was developed for the purpose of combining into one device a piece of equipment that will move various types of material with only one external source. Although similar to a pump, it has no moving parts; therefore there is no need for lubrication or other maintenance and it need not be primed before operation. The compressed air infusion and the two (2) internal hollow rods control the suction in and outward flow of material. Furthermore, it can instantly move from one (1) type of material to another (i.e. from liquid to slurry to dry material) without changing filters, etc., since there are none. It is also different from other high pressure nozzles for the reasons stated above. Current problems in the moving of materials centers on the fact that different pumps and/or nozzles are needed depending on the type and volume of material to be moved or introduced into an existing supply of material. Furthermore, the same need occasional maintenance and are therefore necessarily unavailable to be placed in service. References are made to U.S. Patent Classification Suggested Classes 239, 417 and 137 and are not meant to be totally inclusive.

### BRIEF SUMMARY OF THE INVENTION

Material is gathered at the inlet end of the invention and is expelled at the outlet end as a result of direct compressed air injection into the nozzle. As stated above, this invention greatly simplifies the movement of virtually any type of material regardless of the amount of said material. The actual size of the nozzle and the volume of introduced compressed air are the variables. The advantages of the invention include, but are not limited to, the fact that the nozzle can be moved from one (1) type of source material to another virtually without changing any part of the nozzle. Therefore, it can be used to move dry material and then instantly used to move wet or slurry material virtually without the need to change any part of the nozzle.

### BRIEF DESCRIPTION OF THE SEVERAL VIEWS OF THE DRAWING

FIG. 1. An exterior elevation of the invention from the top. The compressed air inlet is shown closest to the suction or upstream inlet. The velocity or downstream outlet is located at the opposite end.

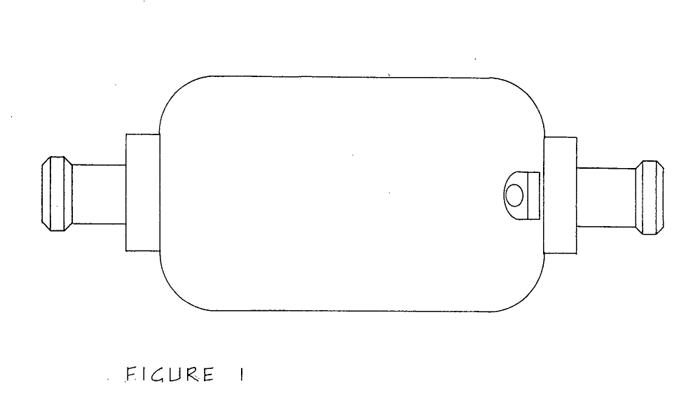

FIG. 2. Is a view of the invention showing the internal air chamber, the hollow suction inlet tapered rod and the hollow velocity outlet rod.

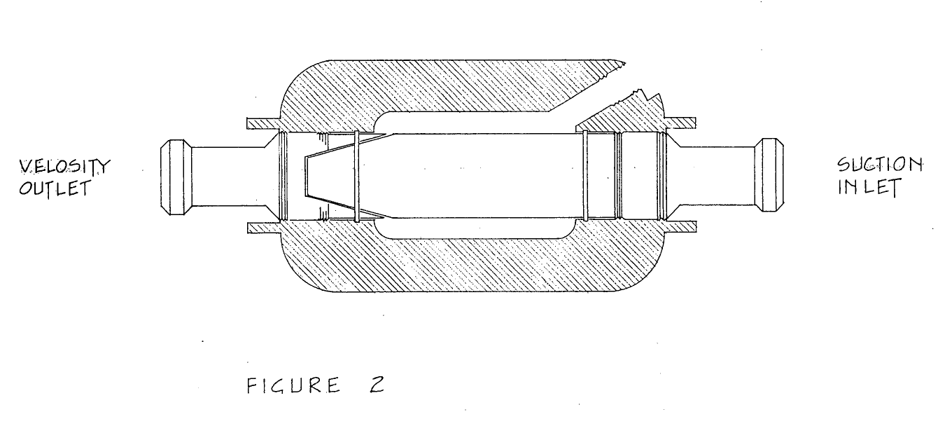

FIGS. 3 and 3A. Is a separate view of the hollow suction inlet tapered rod, and the velocity outlet rod and the internal vortex pattern of both. FIG. 3A is a cross section view of the vortex pattern of each hollow rod.

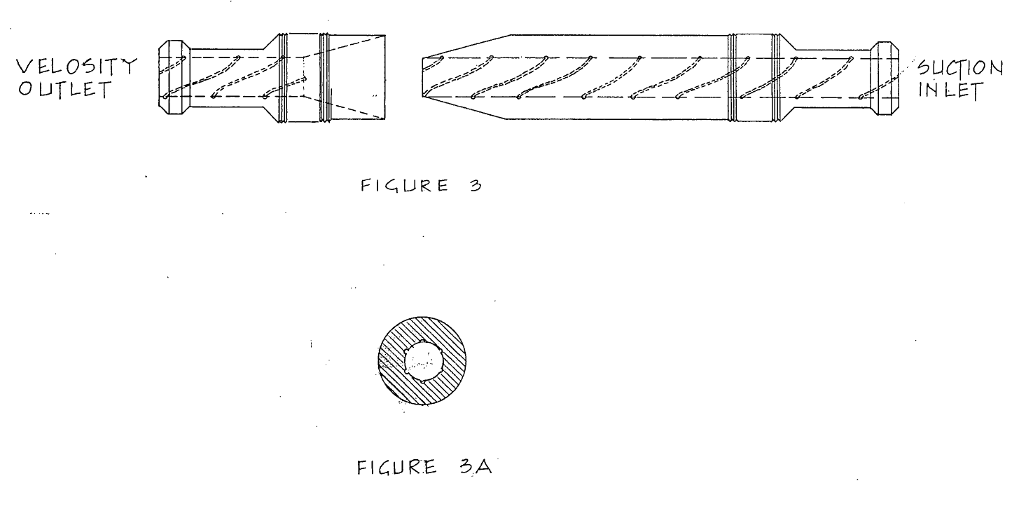

### DETAILED DESCRIPTION OF THE INVENTION

The present invention relates to a unique high pressure nozzle that operates through the injection of compressed air directly into the nozzle. The result is the simultaneous suction of material into the upstream inlet opening of the invention and the high pressure disbursement of the material by ejection through the downstream outlet end of the invention (the velocity outlet).

High pressure nozzles are widely used commercially and by the general public and have been in use for many years. Many operate by the action of constricting the flow of the material, whether it is liquid, slurry or other material. The very act of constricting the flow increases the pressure of the material being expelled.

High pressure nozzles other than the invention herein are used to discharge material that has already been pressurized and the nozzle controls the distribution pattern of the material being sprayed, diffused or otherwise discharged. Some high pressure nozzles include internal filters and other items that require periodic maintenance, whereas the invention herein has none.

A common denominator to other high pressure nozzles is that the material supplied to the nozzle has already been energized by constriction or by a separate energy source prior to introduction to the nozzle.

The invention herein provides an improved high pressure nozzle. The energy for diffusing the material to be dispersed is supplied directly to the nozzle independent of the material that is to be disbursed. Therefore, there is no need to independently energize the material.

The energy pressure is supplied directly to the chamber by the injection of the compressed air. The material to be dispersed is drawn in through the inlet opening, travels along the longitudinal axis of the inlet internal hollow rod in the chamber and exits through the velocity outlet hollow rod. The distance between the inlet hollow rod and the outlet hollow rod can be adjusted by turning either one in a clockwise or counterclockwise rotation. The velocity outlet hollow rod can receive the tapered end of the internal hollow rod thereby providing operational adjustments when necessary. This can be accomplished while the nozzle is operating, therefore eliminating the need to suspend or interfere with the continuous operation of the invention.

The volume of the material drawn into the chamber is controlled by the positions of the inlet hollow rod and the outlet hollow rod, as well as the amount of compressed air injected into the chamber. The amount of pressure generated and the force of the material being expelled through the outlet end hollow rod is also controlled by the position of these hollow rods and the amount of compressed air injected into the chamber. The tapered or male end of the inlet hollow rod can be received by the angular female end of the outlet rod since both have the same fixed angle. Both the tapered male end of the inlet hollow rod and the female end of the outlet hollow rod are easily changed since both are threaded to screw and unscrew into the chamber.

The male end of the inlet hollow rod is adjusted along the longitudinal axis of the chamber toward the female end of the outlet hollow rod by incrementally turning the hollow rods clockwise or counterclockwise at the point where the threaded ends of the hollow rods engage the threaded ends of the chamber.

The adjustment of the hollow rod combined with the volume of compressed air injected into the chamber controls the volume of the material entering the nozzle and the force of the material being ejected.

The internal hollow rod and the outlet hollow rod both contain a continuous series of grooves that create a vortex effect thereby creating a vacuum that aids in the suction of material as well as a uniform ejection of the material.

Unlike other high pressure nozzles, the invention operates independent of the need for an external pump or other device with which to draw the material into the invention, whether the material is liquid, slurry or dry. When switching from one type of material to another, there is no need to change or adapt the invention. The injection of the compressed air acts as a pump in that it provides the energy necessary to draw the material into the nozzle while simultaneously ejecting it under increased pressure. However, unlike a pump, the invention never loses its' prime since there is no priming required.

Moreover, due to the absence of continuously moving internal parts and the ability to virtually instantaneously move from one (1) source material to another, combined with the ability to deploy a series of nozzles, this invention is well suited for various applications. These applications include, but are not limited to, the following: clean crude oil spills on any bodies of water as well as land masses; move materials on construction sites; clean highway accident spills; remove high ignition point materials; remove hazardous waste materials directly into appropriate containment vessels and it can also function as the direct injection of fluids in addition to compressed air. Therefore, the uses of the invention herein are widespread.

1. High pressure nozzle for collecting matter directly into an inlet end and ejecting it from an outlet end by the injection of compressed air directly into the nozzle.

2. High pressure nozzle according to claim 1, characterized in that there is a main suction inlet hollow rod with an upstream inlet end and a downstream outlet end.

3. High pressure nozzle according to claim 1, characterized in that there is a velocity outlet hollow rod whose female end can meet the male end of the suction inlet hollow rod.

4. High pressure nozzle according to claim 1, characterized in that a chamber surrounds the inlet hollow rod and the outlet hollow rod and the chamber has an upstream inlet end and a downstream outlet end that interact with the injection of compressed air through a separate inlet opening.

5. High pressure nozzle according to claim 1, characterized in that compressed air injection means interacting with the chamber to pressurize the compression chamber to drive a high-speed air stream into the chamber from a compressed air source through a separate compressed air inlet opening.

6. High pressure nozzle structure according to claim 1, characterized in that the suction inlet hollow rod is comprised of an upstream inlet end and aligned downstream outlet end. The gap distance between the male end downstream outlet end of the inlet hollow rod and the female end of the velocity outlet hollow rod, comprises the injection passageway which is an annular conical passageway.

7. High pressure nozzle structure according to claim 6, characterized in that the suction inlet hollow rod is axially adjustable in the chamber relative to the female inlet of the velocity outlet hollow rod and the outlet hollow rod is axially adjustable in the chamber relative to the male outlet end of the suction inlet rod.

8. High pressure nozzle structure according to claim 7, characterized in that the hollow rods are threaded and engage in threaded bores in the upstream inlet end of the chamber, and the downstream end of the chamber and are axially adjustable by rotating it incrementally into or out of the chamber. Thereby increasing or decreasing the dimension of the injection passageway.

9. High pressure nozzle structure according to claim 7, characterized in that the downstream outlet end of the suction internal hollow rod is shaped so that it merges with and can be completely seated in the female inlet end of the outlet hollow rod affixed to the outlet end of the chamber. Thereby increasing or decreasing the injection passageway.

10. High pressure nozzle structure according to claim 1, characterized in that the inlet suction hollow rod and the outlet velocity hollow rod are continuous pieces with internal grooves that create a vortex effect that can extend through the length of the chamber.

11. High pressure nozzle structure according to claim 1, characterized in that the compressed air injection method is by way of compressed air in a separate inlet into the chamber.

12. High pressure nozzle structure according to claim 7, characterized in that the hollow rods are axially displaceable in the chamber and are fixed against axial migration by the threaded ends of the hollow rods fitting into the threaded inlet end of the chamber and the outlet end of the chamber.

13. High pressure nozzle structure according to claim 1, characterized in that the hollow rods contained within the chamber and the chamber itself are all connected simultaneously as one unit to the compressed air source at the compressed air inlet opening.

14. High pressure nozzle structure according to claim 1, characterized in that the hollow rods contained within the chamber and the chamber itself are connected simultaneously as one unit to source of the materiel at the inlet end of the suction inlet of the hollow rod.

15. High pressure nozzle structure according to claim 1, characterized in that the material is drawn into the suction inlet hollow rod through the upstream inlet end of the suction inlet of the hollow rod by virtue of the suction created by the injection of compressed air into the chamber. The material is simultaneously ejected through the outlet end of the velocity outlet hollow rod attached to the chamber outlet end by the force of the compressed air.
